(19) United States
(12) Patent Application Publication
(10) Pub. No.: US 2016/0207368 A1
(43) Pub. Date: Jul. 21, 2016

(54) Vertical Take-Off and Landing Roadable Aircraft

(71) Applicant: Rajesh Gaonjur, Montreal (CA)

(72) Inventor: Rajesh Gaonjur, Montreal (CA)

(21) Appl. No.: 14/544,553

(22) Filed: Jan. 21, 2015

(51) Int. Cl. B60F 5/02; B64C 11/00; B64C 37/00; B64C 27/08

(52) U.S. Cl. CPC B60F 5/02; B64C 27/08; B64C 11/001; B64C 37/00

(57) ABSTRACT

A vertical take-off and landing (VTOL) roadable aircraft which has the features and dimensions of a typical road vehicle is disclosed. When operated on the road the wheels are powered by the engine. When the vehicle is configured for flight, a plurality of propellers is deployed from the storage compartment located on the roof and is powered by the same engine. The conversion process transforms the vehicle into a highly manoeuvrable quadcopter or a multi-rotor aircraft. The design concept enables propellers of relative large diameter to be conveniently secure to the vehicle, while allowing reliable deployment, retrieval and storage of the propellers as required. The total combined area of the propellers enables a low disk loading in the range of some helicopters with equivalent flight efficiency. The propellers are shrouded for safe operation. The conversion is automated, fast, and can be carried out while the vehicle is still moving.

### FIELD OF THE INVENTION

The invention relates to a type of roadable aircraft which in one configuration operates like a convention road vehicle, and in another configuration operates like a highly manoeuvrable multicopter with vertical take-off and landing ability.

### BACKGROUND

Concepts of vehicles which can be driven on land and flown in the air have been proposed ever since the first automobiles and aircrafts were invented. A century later in spite of many developments in automobile and aircraft technology, a roadable aircraft which may have useful application still remain to be invented. Roadable aircrafts are commonly known by several other names such as flying cars, flying jeeps, and others. The design of roadable aircrafts is an exercise of intense compromise in the choice of concept, performance and appearance. The design of roadable aircrafts is made difficult basically because of the conflicting design requirements of aircrafts and road vehicles. Aircrafts need fixed-wings or rotary-wings of significant size in order to achieve flight with reasonable efficiency.

Road vehicles on the other hand, have considerable size and shape restrictions so that they can fit in the general traffic, and use public infrastructures such as roads, tunnels and bridges. Roadable aircrafts usually need to undergo complex transformation whenever they switch between road and flight configurations. Practical concepts of roadable aircraft require design solutions which enable the flight components, such as the wings or rotors, to be easily deployed or stowed away in a compact arrangement whenever required, and preferably within the vehicle. The transformation should further necessitate minimal effort of the user, and is preferably automated.

Over the years, many concepts of roadable aircraft with a wide variety of shapes and performances have been proposed. However, most of these concepts failed to meet general acceptance. Roadable aircrafts which are based on fixed-wing or unpowered rotary-wing concepts, can only be operated from an airport facility or require at least a runway in order to take-off and land. Those based on powered rotary-wings which are not shrouded still need to be operated from helipads or dedicated areas away from obstacle for safety reasons. The need of a roadable aircraft is quite questionable. As a matter of fact, roadable aircrafts would always have poor flying performance compared to aircrafts in general. The extra features and components that are included in these vehicles constitute an extra weigh penalty and also degrade the aerodynamic significantly. However in spite of the obvious disadvantage, roadable aircrafts can have useful applications.

The need of a roadable aircraft, with vertical take-off and landing (VTOL) capabilities is strongly felt in the way warfare is conducted in the modern days. Given that no existing design concepts met the requirement for such a vehicle, DARPA which is an agency of the US department of defence launched a public solicitation recently in the hope that a practical solution may be found. Aircrafts and helicopters, as has been found by experience, are not very effective in guerrilla warfare or any other military missions conducted in urban setting. In these setting, the military still have to rely on land vehicles. Land and road vehicles have increasingly become more and more vulnerable to ambushes as they are confined to predictable routes, and the weaponry of the insurgent has gradually increased in sophistication. VTOL roadable aircrafts would have the ability to avoid these treats, and fly above obstacles and damaged infrastructures. VTOL roadable aircrafts would also be able to operate in very rugged terrain where conventional off-road vehicles would be ineffective. The ability of these types of vehicles to effectively carrying out missions with fewer casualties would allow significant cost reduction compared to land vehicles. VTOL roadable aircrafts can also fulfill several of the missions that are traditionally reserved for helicopters more cost effectively. Roadable aircrafts would operate as land vehicle most of the time, and flying only in case of necessity. The reduction in flying time results in appreciable saving in fuel and maintenance cost compared to helicopters, while maintaining many of the operational advantages. Similarly, these types of vehicles can have useful non-military application. These vehicles can be used in areas where road infrastructures are few and poor. They can be used on humanitarian missions in disaster areas, when infrastructures have been partly destroyed following an earthquake or rended inaccessible due to flooding or other fatalities. These vehicles could also be routinely used in cities, as air ambulances or security patrols, which would avoid traffic jams and access areas faster and more effectively than helicopters.

VTOL roadable aircrafts which can meet these challenging requirements need to be of convenient shape and size, have good road qualities, and at the same time have a reasonable flight range and efficiency. Given that such a vehicle would operate mostly at low altitude with numerous landings in unprepared locations, it should have good hovering capability and excellent manoeuvrability at low speed, similar to helicopters. The conversion time between road and flight configurations need to be very short, and transformation preferably achieved without the need of having to stop, since such vehicle may have to operate in hostile environment. It is also important that the propulsion system can be safely operated in crowded public places, road or roof top. As such, the speed and temperature of the downwash wind from the propulsion system should not be harmful to humans and infrastructures. Similarly, the propulsion system should not become damage, or cause injuries to people in normal operating circumstances.

Concepts of VTOL roadable aircrafts that have been proposed in the past do not have these desirable capabilities as mentioned above, in order to be effective in battlefields or as rescue vehicles. For example, both patents U.S. Pat. No. 3,261,572 and U.S. Pat. No. 5,915,649 disclosed VTOL roadable aircrafts that make use of large open rotors when configured for flight. The large diameter of the open rotors achieve low disk loading with an acceptable efficiency and downwash comparable to helicopters. However, the dangers inherent to open rotor impose many constrains and restrictions in the use of these vehicles. The use of VTOL concepts that that been tested in aircrafts, are not very encouraging either. VTOL concepts, such as tilt-wings, tilt-rotors, rotor-in-wings are complex technologies and for that reason are not widespread in aircrafts even today, and most probably may not be suitable for application in roadable aircrafts, where prolonged slow speed and manoeuvrability is of upmost importance.

### SUMMARY OF THE INVENTION

The main object of the invention is to provide for a concept of a road or land vehicle which can be configured into an efficient and highly manoeuvrable VTOL aircraft.

Another object of the invention is to provide for a VTOL roadable aircraft which can be safely and quickly converted or transformed between ground and flight configuration.

Also another object of the invention is to provide for a VTOL roadable aircraft, which can be operated safely in close proximity of humans and in urban environment.

The embodiments of the invention achieve these objects by disclosing several features. Accordingly, the concept of a roadable aircraft is disclosed comprising of a fuselage or the body of a road vehicle wherein the engine rotates the wheels or a plurality of propellers selectively, depending whether the vehicle is configured for road or flight. The invention comprises methods and means which enable several shrouded propellers or rotors to be conveniently stowed one above another on the roof of the vehicle, so that each of the propellers can be designed almost as large as the legal permissible road footprint of the vehicle. The invention provides a reliable means which enable the propellers to be deployed and retrieved with minimum effort of the pilot. Means and method, describing how the rotor hubs of the propellers connect to the driveshaft of the powerplant onboard the vehicle, are also provided. When the vehicle is configured for flight the propellers are deployed and positioned laterally about the vehicle. The propellers are then powered in order to produce the required amount of thrust so as to enable flight. The combined large disk area of all the propellers ensures a low disk loading and better efficiency. The vehicle is operated similarly to air vehicles commonly referred as multirotor. Embodiments of the invention can be configured in quadcopters, or with lesser or higher numbers of propellers. The vehicle takes-off and lands vertically and is highly manoeuvrable.

The claimed invention is a great improvement on earlier concepts of roadable aircraft comprising of a plurality of rotors or propellers. In disclosed patents as shown in U.S. Pat. No. 5,505,407 and US 2010/0294877 the shrouded or ducted rotors encased in the body of the vehicle are of relatively smaller diameter with a significant high disk loading, making these vehicle unsuitable for prolonged hovering. Other earlier disclosed proposals are either unpractical for road with the propellers permanently fixed to the side of the vehicle, or unsafe with the propellers purposely designed without shrouds so as to facilitate their retrieval and stowing. Designing an acceptable and reliable system that would deploy and retrieved shrouded propellers is challenging. In patent US 2013/0068876 the proposal comprises of a method of retrieving and stowing shrouded propellers on the side of the vehicle. The proposed system occupies much of the useful space inside the vehicle and at the same time limit access inside the vehicle from the side.

Air vehicle with a plurality of propellers or rotors is a widely tested concept and is indeed quite popular in unmanned drones. Manned air vehicles comprising of a plurality of propellers such as the Curtiss-Wright VZ-7 have been successfully tested in the past. The use of a plurality of propellers in roadable aircraft is a promising concept. The ways and method how this can be successfully achieved, and the invention itself will be best understood, by reference to the following description in conjunction with the accompanying drawings.

### BRIEF DESCRIPTION OF THE DRAWINGS

The embodiments of the invention are described with reference to the following drawings:

FIG. 1 is a perspective view of the vehicle configured for use on the road in accordance with an embodiment of the present invention, with the propellers stowed in the storage compartment.

FIG. 2 is a perspective view of the vehicle shown in FIG. 1, configured for flight with the propellers deployed from the storage compartment.

FIG. 3 is a top view of the vehicle in FIG. 1, with the storage compartments removed in order to show the plurality of propellers stowed above the roof of the vehicle.

FIG. 4 is a top view of the vehicle in FIG. 2, with the storage compartments removed and shows the propellers in a deployed position for flight, in accordance to the present invention.

FIG. 5 is a front view of the vehicle in FIG. 2, configured for flight with the propellers deployed.

FIG. 6 is a top view of another embodiment of the invention comprising of a plurality of propellers, with the top cover of the storage compartment removed.

FIG. 7 is a perspective view of the transmission pod which secures the propeller to the structure of the vehicle, in accordance with the present invention.

FIG. 8 is a side elevation of the vehicle shown in FIG. 1, illustrating the internal schematic layout of the powerplant, the transmission, and the driveshafts with connect the propellers and the wheels.

FIG. 9 is a perspective view of another embodiment of the present invention with individual drive systems showing the layout of the plurality of powerplants and the transmission system.

### DETAILED DESCRIPTION OF THE INVENTION

Embodiments of the invention are described with reference to the accompanying drawings. Corresponding components in different drawings and components having similar functions in all the drawings are designated by the same numerals. While one particular embodiment of the invention is described in detail, one skill in the art will understand that other embodiments may have different structures and could be based on a variety of methods of constructions, designs, and choice of technologies.

### General Concept

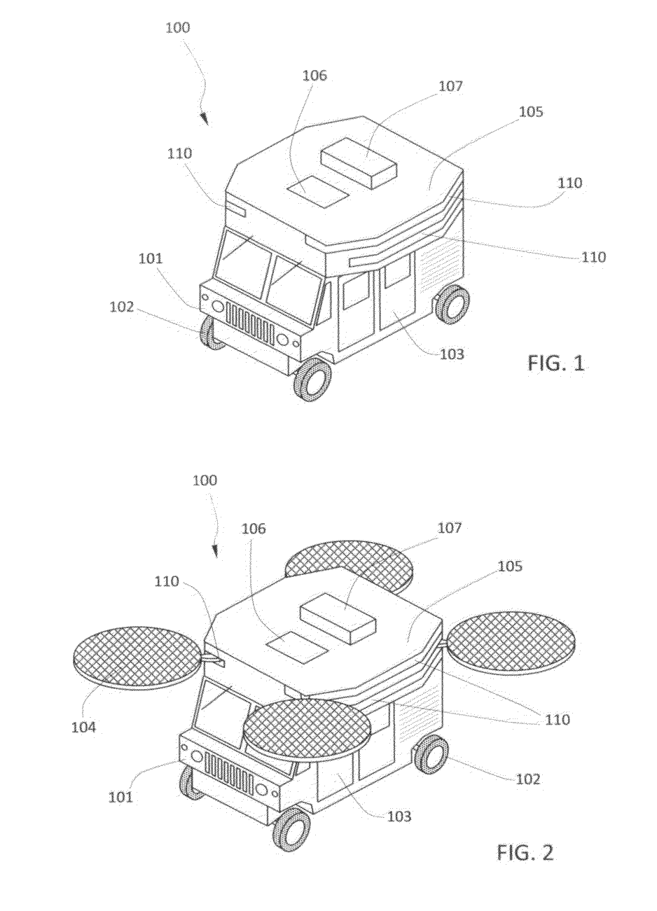

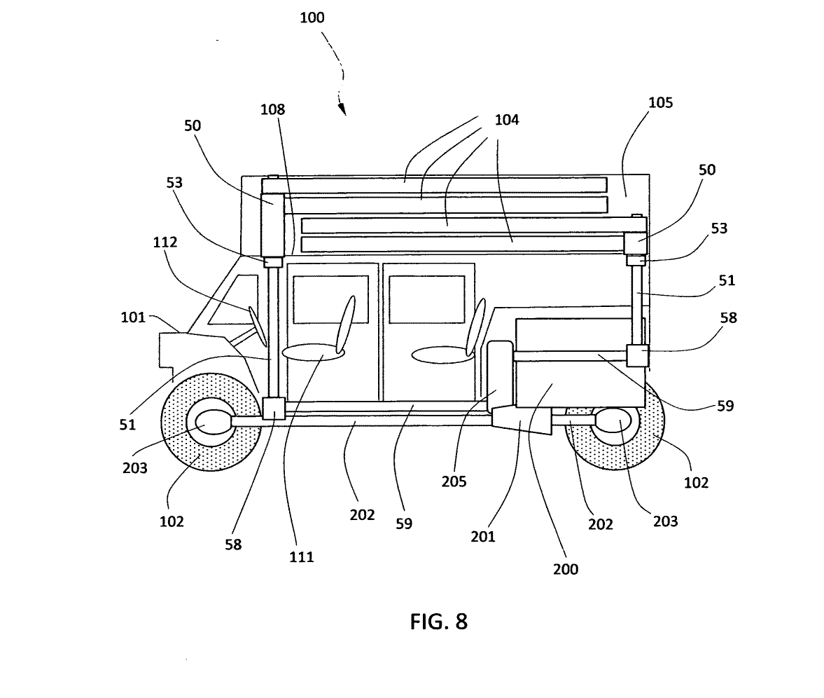

FIG. 1 shows the vehicle 100 when it is configured for use on the road. The vehicle 100 has the appearance and features of a typical road vehicle. The vehicle 100 is designed to have off-road abilities, but other embodiments of the invention may be designed for better or worse road conditions, and may also include amphibious abilities. The coachwork 101 of the vehicle 100 has preferably the box-shape appearance of a van, which may be of monocoque construction or mounted on a chassis or frame which support all components of the vehicle 100. A plurality of wheels 102 support the vehicle 100 on the ground, and enable motion of the vehicle 100 when any of the wheels 102 are powered by the powerplant on board. The wheels 102 are fitted with suspension mechanisms for good road handling capacity and comfort. Side doors 103 enable easy access inside the vehicle 100. The interior is designed according to requirement to suit the number of passengers and the type of goods expected to be carried inside. In FIG. 8 the embodiment comprises of a number of front and back seats 111, in accordance to a layout common in typical road vehicles with a cargo space at the rear. Since the vehicle 100 is also an aircraft, great effort is taken in optimising overall design so as to reduce weight, where intensive use is made of light construction material, so as to maximise the payload during flight.

When the vehicle 100 is configured for flight as shown in FIG. 2, a plurality of propellers 104 are deployed from the storage compartment 105 on either side around the vehicle 100 and firmly locked into flight position. The process of conversion transforms the vehicle 100 into an aircraft which resembles a quadcopter, with similar flight capabilities and characteristics. Other embodiments of the invention may comprise of any suitable numbers of propellers 104. The operation of the propellers 104 produces aerodynamic lift, which enable the vehicle 100 to achieve flight with a high degree of manoeuvrability and appreciable efficiency. The propellers 104 in the illustrated embodiment are shrouded, with the upper and lower openings preferably covered by wire mesh or wire guards, so as to enable very safe operation in close proximity to people and structures. As used herein, the term “propeller” refer to a system comprising of a plurality of blades or wings secured to a rotating hub so as to produce aerodynamic thrust, including those rotor and rotary-wing systems that are used in air vehicles such as helicopters and multi-rotors aircrafts. The propeller could in some other embodiments of the invention comprise of a plurality of small pulsejet or jet engines assembled together in order to have the general shape of the propeller shown in the accompanying drawings. The term “propeller” would also generally refer to any kind of thrust or lift producing devices designed and adapted so as to have the functional ability to be retrieved, deployed and stowed as described in this application.

Stowing the propellers 104 one above another, on the roof of the vehicle is a fundamental aspect of the invention. This enables several propellers 104 of appreciable large diameter to be fitted to the vehicle 100, so that the vehicle has a small footprint when it is configured for road. The diameter of each of the propellers 104 may be designed as large as it is practically possible in order to maximise efficiency, but not exceeding the maximum dimension allowable for road vehicle, if the vehicle 100 is to be used on public road. In general, the diameter of each of the propellers 104 will be as large as the width of the vehicle 100.

The combined larger disk area provided by all the propellers 104 together enables considerable reduction in the disk loading, leading to lower power requirement and higher flight efficiency. This further enable a reduction in the size and power rating of the powerplant fitted in the vehicle 100. By optimising the design of the vehicle 100, it is practically possible to achieve disk loading to within 10 lb/sq. ft or even less. Such roadable aircraft would have flight efficiency and range practically equivalent to some typical helicopters. Other embodiments of the invention may also be designed to operate at a disk loading relatively higher than in helicopters when the flight efficiency is of lesser concern, especially when flight is occasional and of short duration.

A mechanical means is also disclosed which secure the propellers 104 to the vehicle 100, while at the same time enable the propellers 104 to be stowed above one another on the roof of the vehicle 100, and to be readily deployed on the side of the vehicle whenever required. The disclosed method also enables the propellers 104 to be deployed or retrieved as required with relative simplicity, as will be described further.

### Transmission Pod and Propeller Deployment and Retrieval System

The storage compartment 105 as shown in FIG. 1 and FIG. 2 is an enclosed volume or space with several openings 110 on the sides. The propellers 104 are stowed inside the storage compartment 105 when the vehicle 100 is configured for road. When the vehicle 100 is configured for flight, the propellers 104 pivot about their respecting supporting elements out of the storage compartment 105 through the openings 110. The openings 110 will usually be equipped with suitable shutters or covering mechanism which would prevent the ingress and accumulation of dust and particles in the propellers 104, while they are stowed away for long duration. The storage compartment 105 also accommodates the mechanisms that secure and operate the propellers 104. The storage compartment 105 contributes to provide an ecstatic appearance to the vehicle 100 when it is configured for road, with the propellers 104 retrieved inside the storage compartment 105. The storage compartment 105 also provides protection to the propellers 104 and associated components from damage and degradation when the vehicle 100 is used as a road vehicle in a hostile environment. In other embodiments of the invention where the aim to reduce weight penalty is high, the storage compartment 105 may simply denote or describe the space above the roof 108 of the vehicle 100 where the propellers 104 can be retrieved and stationed while not in use.

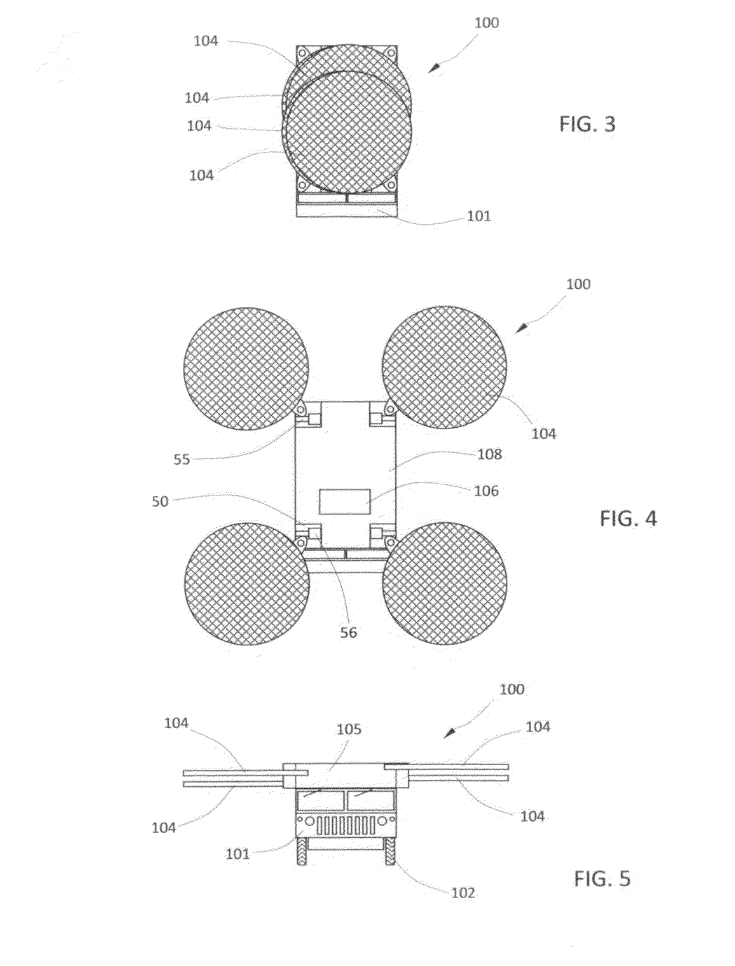

In FIG. 3 and FIG. 4, the storage compartment 105 has been removed in order to shows with clarity the propellers 104 in the retrieved and deployed positions on the roof 108 of the vehicle 100. Each propeller 104 is secured to the vehicle 100 at appropriate location around the edge of the roof 108, as shown on a mechanical system that is labeled as the transmission pod 50. The transmission pod 50 is an important aspect of the invention which combines together several functions in order to enable reliable operation of the vehicle 100. The transmission pod 50 comprises: a means to secure the propellers 104 to the vehicle 100; a means to connect the driveshaft from the engine side to the rotating part of the propellers 104; a means to enable the propellers 104 to pivot about the point of support so that the propellers 104 can be deployed for flight or retrieved in the storage compartment 105; and a means to lock the propellers 104 in the deployed or retrieved position.

Each propeller 104 is secured to the side of the vehicle 100 at a different height, so that each propeller 104 can occupy separate levels inside the storage compartment 105, as shown in FIG. 5. Hence the propellers 104 do not cross the path of each other, as they pivot between the deployed and retrieved position. It is understood that the diameter of the propellers 104 need to be correctly chosen, so that they can pivot and freely move into the space between the plurality of adjacent transmission pod 50 which secure the others propellers 104, while being retrieved for storage or deployed for flight.

When the propellers 104 are deployed for operation, they are preferably positioned as shown in FIG. 4. Viewed from the top, the propellers 104 are s positioned so that they are lateral and symmetrical about the vehicle 100, as this arrangement simplifies the flight control process and systems. View from the front however, the propellers 104 are off-set relative to each other, as shown in FIG. 5. However as the thrust of the propellers 104 are generally directed perpendicular to the horizontal plane of the vehicle 100, this dissymmetry has little significant so incidence on the flight characteristics of the vehicle 100, which in any case can be easily compensated by adjusting the amount of thrust from the propellers 104 individually, if required. The low center of gravity of the vehicle 100 relative to the resultant lift produced by the propellers 104 on the other hand, greatly contributes to the stability of the vehicle during flight.

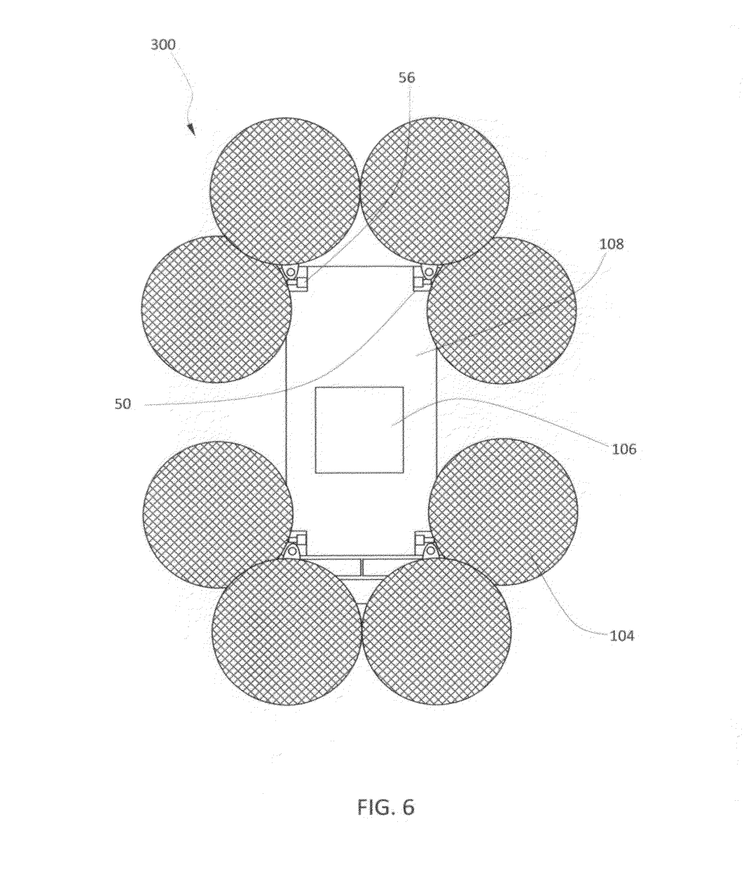

The illustrated embodiment of the invention comprises of four set of transmission hub 50, where each of the transmission pod 50, support a single propeller 104. The vehicle 100 is also designed to have a rather square footprint so as to maximise the area of the propellers 104 that can be stowed within the available footprint of the vehicle 100. Other embodiments of the invention can comprise of different numbers of transmission pod 50. In some yet another embodiment more than one set of propeller 104 may be secured and powered by the same transmission pod 50. Other embodiments of the invention may be design to have a rectangular footprint, and in these cases the plurality of propellers 104 are stowed, one above another and side by side. One such embodiment of the invention is shown in FIG. 6, where the vehicle 300 has the length about twice the width, with as many as eight propellers 104 deployed around the vehicle. When the vehicle 300 is configured for road, the eight propellers 104 are stowed on four separate levels, whereby on each level two propellers 104 are stowed side by side. A single transmission pod 50 is used to secure and power two set of propellers 104.

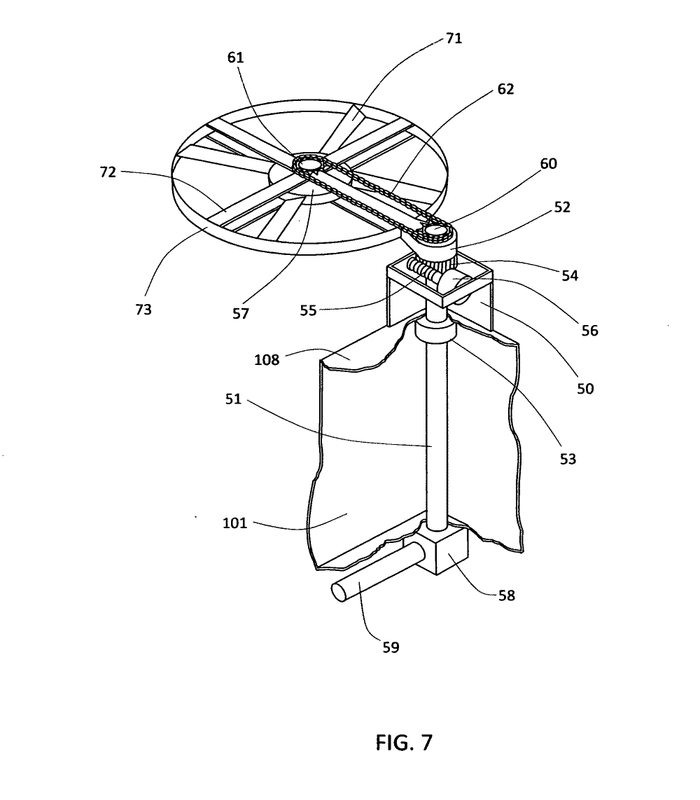

As shown in FIG. 7, the propeller 104 comprises of a hub 57 with a plurality of blades 71, rotatably mounted within a set of support frames 72. The support frames 72 also secure the shroud 73 so as to make the operation of the blades 71 safe. The top and bottom openings of the propeller 104 may be further covered with wire guards so as to enhance safety. The support frames 72 of the propeller are solidly secured to the support component 52. As the support component 52 is rotatably s mounted to the shaft 51, this enable the propeller 104 to be pivoted about the longitudinal axis of the shaft 51. This mechanism allows the propeller 104 to be pivoted about, so as to be deployed for flight or retrieved and stowed above the roof of the vehicle 100. As the shaft 51 is also used as a means to transfer rotational mechanical energy from the engine to the rotor hub 57, the shaft 51 is also rotatably mounted to the structures of the vehicle 100 by at least one support component 53.

In the illustrated embodiment, the gearbox 58 which connect the lower end of the shaft 51, also provide addition support to the shaft 51, and also rotatably secure the shaft 51 to the structure of the vehicle 100. In other embodiment additional support component 53 may be required to reliably secure the shaft 51 to the structure of the vehicle 100. The rotatable support components 52 and 53 comprise of roller or thrust bearings enclosed within appropriate housing arrangements, which minimise friction between the connecting parts.

The upper support component 52 is made to rotate clockwise and anticlockwise by some define amount about the axis of the shaft 51 by the operation of a worm drive mechanism. This enable the propeller 104 to pivot in and out of the storage compartment 105 as required during configuration for road or flight. As shown in FIG. 7, the worm drive mechanism comprises of a worm gear 54 which is secured to the upper support component 52, and a worm 55 which is connected to the drive shaft of the motor 56. The motor 56 is secured to the fixed structure of the transmission pod 50 on the roof 108, within the spare space of the storage compartment 105. The motor 56 is preferably an electrical stepper motor which has the advantage of having relatively simple positioning control system, however any other type of electric motor or any suitable electrical, mechanical, or pneumatic device with a reliable positioning system can be used. A means to lock the upper support component 52 in the desired position as required by the operating configuration of the vehicle 100 is provided. A non-reversible worm drive has the advantage not to require such locking mechanism. However, addition securing devices may be included, if the gears of the worm drive may not withstand prolonged mechanical stresses, or if some other types of reversible gear mechanisms are used.

The shaft 51 also transfers the rotational energy from the powerplant to the rotor hub 57. The shaft 51 can be relatively short in some embodiments, wherein the lower end connects to the transmission shaft of the powerplant by a combination of suitable coupling devices, such as gearbox and additional transmission shafts which are routed in any convenient way in the vehicle. In the illustrated embodiment, the shaft 51 is a continuous vertical shaft which connects to a gearbox 58 in the lower section of the vehicle 100. The gearbox 58 couples the shaft 51 to the horizontal transmission shaft 59, which connect to the transmission 205 below the cabin of the vehicle 100 as shown in FIG. 8. The upper end of the shaft 51 is coupled to a sprocket gear 60 which transfer the rotational energy to another sprocket gear 61 secured to the rotor hub 57 by mean of a roller chain 62. Other means of suitable mechanical power transmission systems such as belt drive or gearbox and drive shaft mechanism may also be used. The overall gear ratio of the drive system from the rotor hub 57 to the output shaft of the engine 200 has to be as per design requirement so that the rotational speed of the rotor hub 57 is within the required operating range. In other embodiments, as shown in FIG. 6, the transmission pod 50 may comprise of additional support component 52 with separate worm drive to secure and operate addition propeller 104.

Persons of skill in the art will understand the mechanical system which secure the propellers 104 to the vehicle 100 and which enable retrieval and deployment of the propellers, as described herein is not limited to the specific embodiment just described. Thus any other securing means may be provided which can reliably deployed the propellers 104 from the roof of the vehicle 100, and then positioned the propellers 104 on the side of the vehicle so as to enable flight, and which later may be retrieved back on the roof of the vehicle so as to enable operation as a road vehicle, as and when required. Similarly, while in the description herein a mechanical means is used to transfer power from the powerplant to the rotor hub 57, in other embodiments of the invention other means based on electrical or compressed fluid may be used. In yet other embodiment, the powerplants may be contained within the individual propellers 104.

The propeller 104 is designed for maximum efficiency as the diameter of the rotor is limited by the maximum allowable footprint of the vehicle 100. The thickness of the propeller 104 is also preferably made as small as it is practically possible, so that the storage compartment 105 is not excessive bulky and the vehicle is of an acceptable overall height. Such consideration would influence many of the design of the propeller such as the number of blades 71, the speed of rotation of the hub 57, the shape of the shroud 73. The blades 71 can be designed to have a fixed pitch so as to simplify the construction of the rotor hub 57. However blades 71 with variable pitch rotating at fix speed has the advantages of reducing the design complexity of the transmission 205, especially when a single engine 200 is used to power all the propellers 104 at the same rotational speed. Efficiency of the propeller 104 and the amount of aerodynamic thrust can be further increased by using a pair of contra-rotating propeller blades preferably within the same shroud 73. In this arrangement the sprocket gear 61 drives two separate set of blades on two separate rotor hubs 57, about the same axis in counter-rotation by mean of appropriate gear mechanism within the two rotor hubs 57.

### Powerplant and Transmission

The powerplant as understood in the description herein refer to the equipments and the power source on board the vehicle 100 which drive the propellers 104 by any suitable transmission system. As shown in FIG. 8, the vehicle 100 is powered by an engine 200 in both it roadable and in flight mode. The engine 200 can be of any type such as, combustion, electrical, gas turbine, or of any hybrid design, as long as it can reliably and efficiently power the vehicle 100 in both modes. The engine 200 may also comprise of a plurality of independent engines couple together so as to increase reliability. Given that the power requirement during and flight mode are very different, embodiments of the invention may comprise of one type of engine to power the vehicle during road configuration, and another type of engine to power the vehicle during flight configuration. One possible choice of powerplant is the turboshaft engine. Turboshaft engines are widely used to power helicopters because of their high reliability, high energy output, compactness and low weight. During road configuration the wheels 102 may be driven by less powerful alternative engine or electrical motors which run on energy produced by the same turboshaft engine and stored in electrical accumulators.

The wheels 102 are powered in a four-wheel drive arrangement by the engine 200 through the transmission or gearbox 201, the shaft 202 and the differentials 203. Other embodiments of the invention may be designed as front-wheel or rear-wheel drive. The propellers 104 are powered through a set of horizontal drive shafts 59 connected to the gearbox 205. The gearbox 205 is powered by the engine 200 thorough the transmission 201. The design of the gearbox 205, as will be described further depend on the choice of propeller 104 which maybe of the fixed or variable pitch type. The transmission 201 drives the wheels 102 or the propellers 104 selectively with the appropriate gear ratio. The transmission 201 may allow a rolling take-off, that enables the vehicle to transit from road to flight mode without the need to stop. During rolling take-off, the transmission 201 continues to power the wheels 102 until the vehicle 100 has taken-off from the ground.

It should be understood that the transmission systems and the shafts system which couple the wheels 102 and the propellers 104 to the engine 200 can be designed in a variety of ways. In the illustrated embodiment separate gearbox devices 201 and 205 has been preferred. In another embodiment a single gearbox may be used instead, with as many outgoing shafts to rotate the propellers 104 or the wheels 102. In yet other embodiment a single outgoing driveshaft from the main transmission gearbox may be made to drive the wheels 102 or the propellers 104 with the help of appropriated coupling and clutch mechanism.

Given that the vehicle 100 is designed for flight, the mass center of the vehicle 100 is generally located in the middle in alignment with the resultant lift produce by the propellers 104, so as to achieve a stable and controllable flight. As such, a rear mid-engine arrangement is preferred as it enables the engine 200, which is heavier and more bulky than engine commonly used in conventional road vehicle, to be installed without major difficulty, while the passengers and payload are located rather at the front. This arrangement enables a good weight distribution, while at the same time provides good forward vision for the driver/pilot necessary during slow flight and precise manoeuvring. The rear location of the engine 200 also ensures a reduction of noise level inside the cabin.

### Flight Control

In order to achieve flight, the four set of propellers 104 are operated in a similar s way as a conventional quadcopter or other multirotor vehicles. The plurality of propellers 104 produces thrust generally directed downward which enable the vehicle 100 to achieve vertical take-off, vertical landing, hover, and horizontal flight. The plurality of propellers 104 operates coaxially so that the reactions of the propellers 104 on the vehicle 100 cancel each other mutually during normal operation, so the need of lateral anti-torque rotor as found in most conventional helicopter is avoided. The propellers 104 are positioned preferably symmetrically and laterally opposite each other. The resultant thrust generated by the propellers 104 need be aligned with the center of gravity of the vehicle 100, in order to achieve stable flight. The propellers 104 are preferably of identical construction. Lateral displacement and forward flight is achieved by pitching the vehicle 100 in the direction of the flight. Pitching is generally done by varying the thrust of single or group of propellers 104 relative to other group of propellers 104. Yaw control can be achieved by modulating the speed of one or group of propellers 104 relative to other group of propellers 104 so that the reactions of the propellers 104 on the vehicle 100 do not completely cancel each other. The resulting turning moment causes the vehicle 100 to turn about its vertical axis and hence to be steered in the desired direction.

The pitch of the blades 71 may be permanently fixed or adjustable. When the pitch of the blade 71 is adjustable, the rotor hub 57 will generally rotate at constant speed and the amount of aerodynamic thrust is modulated by adjusting the pitch of the blades 71. The gearbox 205 is of simple mechanically construction because all the outgoing shafts 59 rotate at the same speed. When the pitch of the blades 71 is fixed, the modulation of aerodynamic thrust is achieved by modulating the speed of rotation of the rotor hub 57. In this case the gearbox 205 would include means to modulate the speed of rotation of the outgoing shafts 59 independently. Such means may comprise of externally mounted devices on the outgoing shafts 59 such as fluid coupling mechanisms or electromagnetic clutches.

The propeller 104 may comprise of two set of rotor hubs 57 with respective blades 71 operating in counter-rotation similar to contra-rotating propellers or rotors, within a single shroud 73. In spite of the relative mechanical complexity of the design, such contra-rotating propellers 104 are of particular advantage for use in the vehicle 100 where the total disk area remains limited by the dimension of the storage compartment 105, and legal restriction. As contra-rotating propellers 104 produce more thrust for a given disk area, they contribute significantly in reducing the size of the engine 200, and improve the efficiency of the vehicle 100. The contra-rotating blades of the propellers 104 may be of the fixed pitch or variable pitch type, and would require the appropriate control mechanism, as described earlier in order to vary the thrust for flight control purposes. Because contra-rotating propellers are generally torque neutral, varying one or group of propellers 104 would not provide yaw control on the vehicle 100. The torque necessary for control of the vehicle 100 could be generated by winglets installed in the downwash of the propellers 104, or by small lateral thrusters installed at appropriated location on the body of the vehicle 100. These thrusters may be powered preferably by compressed air generated by the engine 200.

Flight control may be achieved to some extent by displacing the resultant lift of the propellers 104 with reference to the center of gravity of the vehicle 100. By operating the worm 55, the relative position of the propellers 104 around the vehicle 100 may be modified during flight. For example, in order to move the vehicle 100 forward, the propellers 104 are displaced backward. As the result, the resultant lift generated by the propellers 104 are relocated behind the center of gravity of the vehicle 100, pitching the vehicle 100 downward and initiating forward movement. Repositioning of the propellers 104 may be also necessary in order to align the center of lift with the mass center of the vehicle 100 for the purpose of stationary hover or precision landing, especially when the payload and passengers are not evenly distributed.

### Operation

When configured for road, the vehicle 100 is operated like a conventional four wheel-drive vehicle. The wheels 102 are powered by selecting the appropriate gear ratio in the transmission 201 and by modulating the engine power output with the aid of a classical foot petal. The transmission system may be manual or of the automatic type. Steering wheel 112 as shown in FIG. 8, or other equivalent system controls the direction of travel by operating on the wheels 102 same like in convention road vehicle.

Conversion between ground and flight mode is preferably automated and is enable by a command from the driver in the cabin. Activation of the flight mode operates the motors 56 on each of the transmission pod 50, which by turning the respective worms 55 deploy, position and lock all the respective propellers 104 in the flight position. The gearbox 205 is engaged to the transmission 201 and the propellers 104 are ready to operate. During flight, the engine 200 is control by a governor mechanism with limited control by the pilot. When the propellers 104 are of the fixed pitch type, the pilot may only need to modulate the speed of the engine 200 within permissible range for safe operation. In the case the propellers 104 are of the variable pitch type with collective control, the engine 200 is then operated most likely at a constant optimum speed. More elaborate automatic control system would reduce the workload of the pilot by automatically handling certain part of the flight operation such as: hovering; maintaining safe flight altitude during horizontal flight; take-off; and landing, while the pilot mostly handle flight direction and speed. The flight commands are given by any appropriate input devices such as joystick, pedals and keypads to the control systems which in turn control the thrust produced by the propellers 104 as necessary to produce the necessary pitch inclination, the amount of yaw control, or operate any other necessary actuators and control surfaces. The control systems would further include many safety features that eliminate erroneous input from the pilot. The vehicle 100 might likewise include flight navigation equipments in accordance with the nature of the mission the vehicle is designed for.

While the vehicle 100 internal and external design may be very similar to road vehicle, it may comprise of many other features that have significant importance in such flying machine. An access trap 106, as shown in FIG. 1 is provided on the roof, and is accessible from inside the cabin only when the propellers 104 are deployed. This enables the vehicle 100 to be used as a hovering platform in specific cases when it is more convenient to carry out mission from the roof of the vehicle 100, for example reaching side of tall buildings, cliffs, or under overhanging structures such as bridges.

Vehicle 100 which comprises of propellers 104 with fixed pitch blade 71 would have no autorotation capability. The propellers 104 with variable pitch blade 71 may provide some autorotation capability if they have sufficient inertia. In either case, an emergency ballistic parachute 107 is provided on the roof of the vehicle 100.

Deployment of the ballistic parachute 107 enable the vehicle 100 to drop safely to the ground in case of flight emergency situation, such as; complete engine failure, dissymmetry of lift due to failure of propellers 104, loss of flight control, and other major components failure.

### Embodiment with Multiple Engines

Redundancy of vital components is an important issue due to poor autorotation ability. Engine failure can be easily overcome by the use of more than one engine in order to power the propellers 104. Hence the engine 200 may comprise of two or more engines coupled together and power the transmission 201 through a common driveshaft. In the case of failure of any of the engines, the faulty engine is automatically disconnected, while the others engines continue to operate, enabling the vehicle 100 to land safe or if necessary to complete the flight mission.

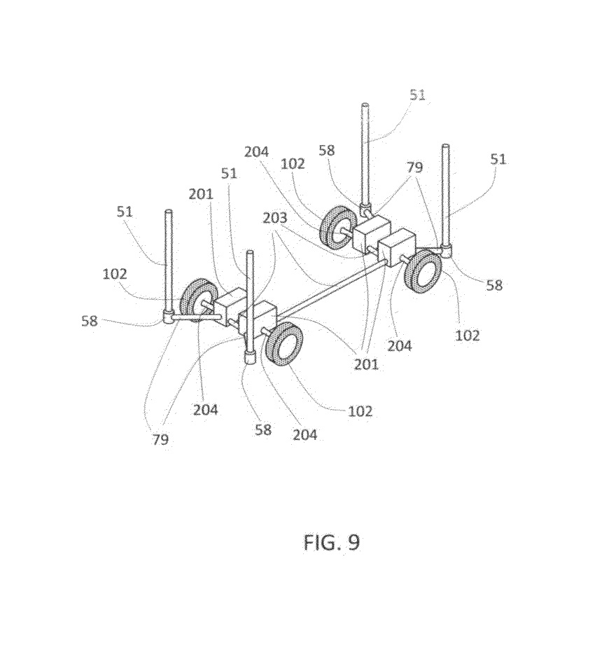

While several configurations of multiple-engine design are possible, one advantageous concept is when each propeller 104 or group of propellers 104 are powered by separate engine. As shown in FIG. 9, each vertical shaft 51 connects to a separate engine 201. The engines 201 are mounted close to their respective vertical shafts 51, in a convenient and compact arrangement mounted on the side of the vehicle 100. Since the engines 201 drive the respective wheels 102 and the propellers 104 independently, the design enables significant reduction in the weight of the vehicle 100. The need of transmission and differential systems are eliminated. The length of the interconnecting drive shafts is also significantly reduced. Since the speed of each of the propeller 104, or group of propellers 104 can be independently controlled by modulating the speed of their respective engine 201, the flight control is simplified, together with the elimination of several related mechanical systems. The need of complex transmission system or collective control system for propellers 104 with variable pitch, as described earlier are not required. The synchronisation between the multiple engines 201 are carried by an electronic control system rather than by mechanical means. In order to further improve redundancy a set of driveshafts 203 may be provided, which through a system of clutches ensure that in case of single or multiple engines failure, power can be transferred from any of the healthy engines 201 to any of the propellers 104. These driveshafts 203 may be of lighter construction as they are design for use on rare occasion and for short duration.

Embodiments of the present invention would comprises of a fuselage or body that have the appearance and ability of a wide range of road vehicles, such as microcars, city car, sport cars, off-road and all-terrains vehicles. Embodiments of the invention are not limited to four-wheel vehicles but could be adapted to three-wheelers or vehicles comprising of a plurality of wheels. While the invention offers many advantages for use on the road, other embodiment may be optimised for flight. Embodiments of the invention would comprise of rotors embedded in a shroud or structure, which may be able to generate aerodynamic lift as fixed-wings, and hence improve the flight range and efficiency. Such vehicle may include additional wings and propellers to produce horizontal thrust. Embodiment of the invention could be manned or unmanned drones designed to operate in specific environments and missions.

While the above description has detailed the features of the invention it is understood that various omission, substitution and changed may be made by those skilled in the arts without departures from the spirit and scope of the invention, and that the specification and drawings are to be considered as merely illustrative and not limiting:

The embodiments of the inventions in which an exclusive property or privilege is claimed are defined as follows:

1. A vehicle having a road configuration and a flight configuration comprising :
a fuselage or body of the vehicle;
a plurality of wheels which support the said fuselage on the ground, wherein at least one of the said wheels is rotated by at least one engine to enable the said vehicle to move during said road configuration;
a plurality of propellers, which is rotated generally in a horizontal plane by at least one engine so as to produce aerodynamic lift and enable the said vehicle to fly during said flight configuration;
a means which secure the said propeller to the said vehicle;
a means which enable the said propellers to be retrieved and stowed above one another on the roof of the said vehicle during said road configuration;
and a means to deploy the said propellers from the stowed position to the side of the said vehicle for use during said flight configuration.

2. A vehicle as recited in claim 1, wherein said propellers are shrouded, or enclosed so that the said vehicle can be operated safely.

3. A vehicle as recited in claim 1, wherein the said propeller comprises of a rotor hub with a plurality of blades extending radially from the said rotor hub.

4. A vehicle as recited in clam 3, wherein the pitch of the said blades may be varied so as to modulate the amount of aerodynamic lift

5. A vehicle as recited in claim 1, wherein the said propeller comprise: of a first rotor hub having a plurality of blades rotating in one direction; and a second rotor hub having a plurality of blades rotating in counter-rotation to the said first rotor hub.

6. A vehicle as recited in claim 5, wherein the pitch of the said blades may be varied so as to modulate the amount of aerodynamic lift.

7. A vehicle as recited in claim 1, comprising of a storage compartment above the roof of the said vehicle so as to enclose the said propellers during the said road configuration, the said storage compartment comprising of side openings through which the said propellers are able to pass, when the said propellers are deployed during said flight configuration.

8. A vehicle as recited in claim 1. Wherein the said wheels and the said propellers may be rotated selective by the same engine or same group of to engines when the said vehicle is in said flight configuration or said road configuration.

9. A vehicle as recited as in claim 1, wherein each of the said propellers or group of said propellers are rotated by independent engine.

10. A vehicle as recited in claim 9, wherein the plurality of said propellers or said engines are mechanically interconnect in order to protect against single engine and multiple engines failures.

11. A means which secure the said propeller to the said vehicle and enable the said propeller to be deployed for flight configuration or retrieved for road configuration,
the means comprising:
a shaft generally positioned vertically rotatably mounted and secured to the side of the said vehicle;
a supporting component rotatably mounted to the said shaft, which secure the said propeller to the said shaft ;
a first gear device mounted on the longitudinal axis of the said shaft and firmly secured to the said supporting component;
a second gear device which meshes with the first said gears device and is rotatably mounted and secured to the structure of the said vehicle, so that the rotation of the said second gear device enables the said propeller to pivot about the axis of the said shaft.

12. A means as recited in claim 11, wherein the said second gear device is rotated by a motor, in order to pivot the said propeller about the axis of the said shaft.

13. A means as recited in claim 11, wherein one end of the said shaft is connected to the engine, and the other end of the said shaft rotates the hub of said propellers by means of a transmission mechanism.

14. A mean as recited in claim 13, wherein a chain transmission comprising of a first sprocket gear mounted to one end of the said shaft and the second sprocket gear mounted to the hub of the said propeller, rotates the said propeller.

15. A vehicle as recited in claim 1, comprising of additional wings secured to the said vehicle so that to generate aerodynamic lift and control.
